(19) United States
(12) Patent Application Publication
(10) Pub. No.: US 2026/0350067 A1
(43) Pub. Date: Nov. 5, 2026

(54) AUGMENTATION OF INPUT DATA FOR ENHANCED RESPONSE GENERATION

(71) Applicant: The Toronto-Dominion Bank, Toronto (CA)

(72) Inventors: Anil Stewart Bakhle, Guelph (CA); Christopher Robert Halabecki, St. George Brant (CA)

(73) Assignee: The Toronto-Dominion Bank, Toronto (CA)

(21) Appl. No.: 19/194,200

(22) Filed: Apr. 30, 2025

(51) Int. Cl. G06F 16/334; G06F 16/3329; G06F 16/335

(52) U.S. Cl. CPC G06F 16/334; G06F 16/3329; G06F 16/335

(57) ABSTRACT

An example operation may include at least one of receiving a natural language input that is input to a source device, querying an external data service for additional data based on the natural language input and receiving the additional data from the external data service, augmenting the natural language input based on the additional data to generate an augmented input, generating a response to the natural language input based on the augmented input, and outputting the response to the source device. The example operation may further include an AI agent that performs an action based on the response.

### BACKGROUND

Various artificial intelligence (AI) models, such as large language models (LLMs), are able to provide answers based on queries or prompts. Sensitive data or confidential data should not be input into the AI models, as the data may become public or may be used to further train the AI models. In some cases, models can be restricted to prevent consumption of sensitive data during input. However, the missing input data may prevent the model from providing a complete response to the query.

### SUMMARY

One example embodiment provides an apparatus that may include a memory, and at least one processor communicably coupled to the memory, where the at least one processor may at least one of receive a natural language input that is input to a source device, query an external data service for additional data based on the natural language input and receive the additional data from the external data service, augment the natural language input based on the additional data to generate an augmented input, generate a response to the natural language input based on the augmented input, and output the response to the source device.

Another example embodiment provides a method that includes at least one of receiving a natural language input that is input to a source device, querying an external data service for additional data based on the natural language input and receiving the additional data from the external data service, augmenting the natural language input based on the additional data to generate an augmented input, generating a response to the natural language input based on the augmented input, and outputting the response to the source device.

A further example embodiment provides a computer-readable medium comprising instructions, that when read by a processor, cause the processor to perform at least one of receiving a natural language input that is input to a source device, querying an external data service for additional data based on the natural language input and receiving the additional data from the external data service, augmenting the natural language input based on the additional data to generate an augmented input, generating a response to the natural language input based on the augmented input, and outputting the response to the source device.

### BRIEF DESCRIPTION OF THE DRAWINGS

FIG. 1A is a diagram illustrating a process of augmenting input data for execution by a remote AI model according to examples and features of the instant solution.

FIG. 1B is a diagram illustrating a process of generating a response based on code from the remote AI model according to examples and features of the instant solution.

FIG. 2A is a system diagram illustrating integration of an AI model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 3 is a system diagram illustrating an operating environment for a communication service according to the examples and features of the instant solution.

FIG. 4A is a diagram illustrating a process of enhancing input data to an AI model according to the examples and features of the instant solution.

FIG. 4B is a diagram illustrating a process of generating a response based on the enhanced input data according to the examples and features of the instant solution.

FIG. 5A is a diagram illustrating a process of receiving source code and supplemental data according to the examples and features of the instant solution.

FIG. 5B is a diagram illustrating a process of executing the source code on the supplemental data to generate a response to a natural language input according to the examples and features of the instant solution.

FIG. 6 is a diagram illustrating a process of a GUI being used to interact with the system described herein according to the examples and features of the instant solution.

FIG. 7A is a diagram illustrating a method of generating a response with supplemental content according to the examples and features of the instant solution.

FIG. 7B is a diagram illustrating an additional method of generating a response with supplemental content according to the examples and features of the instant solution.

FIG. 8 is a diagram illustrating a computing system that may be used in any of the example embodiments described herein.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to an artificial intelligence (AI) system that can enhance input data that is input to an AI model, such as an LLM, when generating a response to the input data. The input data may contain a natural language input such as a query, question, or the like. The input may be in text format. The system described herein may identify additional content that is associated with at least one of a user, an account, a device, a payment card, and the like, and ingest the additional data from an external service. In some embodiments, the external service may require consent from the user to provide their content. The additional data from the external service can be acquired automatically, and it can be used by the AI model to generate more accurate responses to the natural language inputs that are received.

The additional data may be identified using various search criteria, for example, name, address, education information, work information, vehicle information, tax information, credit information, and the like. The additional data may provide additional content that can help the system create a “bigger picture” of the person that it is conversing with.

According to various embodiments, the system may receive a natural language input that is input to a source device. For example, the input may include a question, a query, a statement, personal information, and the like. The system may query an external data service for additional data based on the natural language input and receive the additional data from the external data service. As mentioned, the additional data may enhance the natural language content giving the AI model more information to consider when generating a response. The system may augment the natural language input based on the additional data to generate an augmented input. Furthermore, the system may generate a response to the natural language input based on the augmented input. Furthermore, the system may output the response to the source device.

In some embodiments, the system may combine the natural language input with the additional data to generated the augmented input and generate the response based on execution of an artificial intelligence (AI) model on the natural language input combined with the additional data. In some embodiments, the system may display a graphical user interface (GUI), receive confirmation of an accuracy of the additional data from the source device through the GUI, and validate content within the natural language input based on the additional data. In some embodiments, the system may receive consent to access the additional data at the external data service through the GUI, and retrieve the additional data from the external data service based on the consent.

In some embodiments, the system may augment the response to include content from the additional data and the outputting comprises outputting the augmented response to the source device. In some embodiments, the system may further receive transfer content from an electronic transfer associated with the natural language input, and the generate the response comprises generating the response based on the transfer content. In some embodiments, the natural language input includes at least one of a name of a person and an identifier associated with the source device and the system may query the external data service based on the at least one of the name of the person and the identifier.

In some embodiments, the system may detect a difference between content in the natural language input and a corresponding content in the additional data, query the source device for clarification of the difference, and generate the response based on the clarification of the difference. The content may include personally identifiable information (PII), such as name, address, phone number, email address, account numbers, and the like.

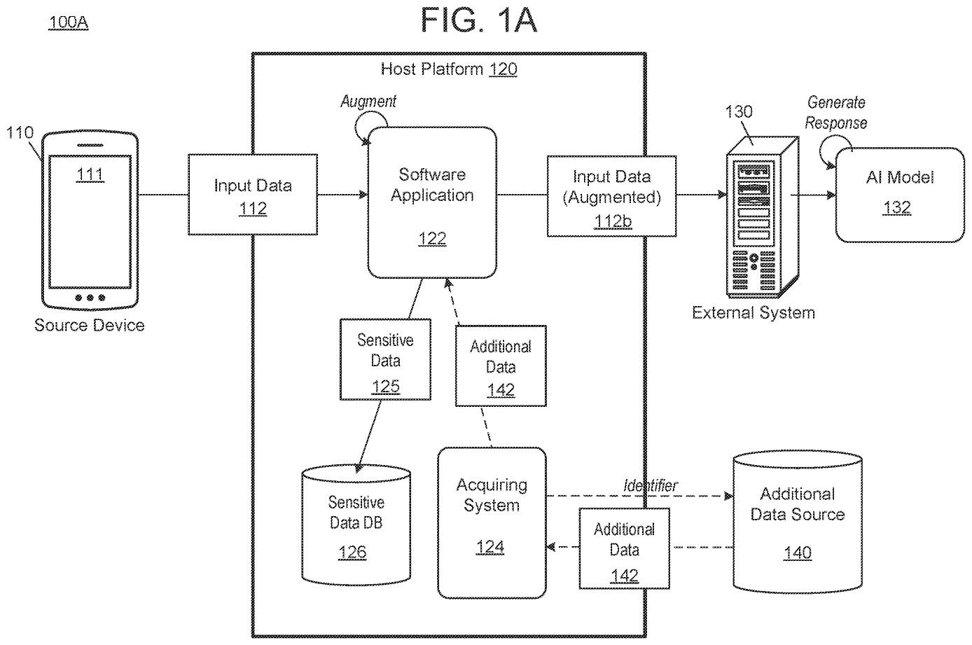

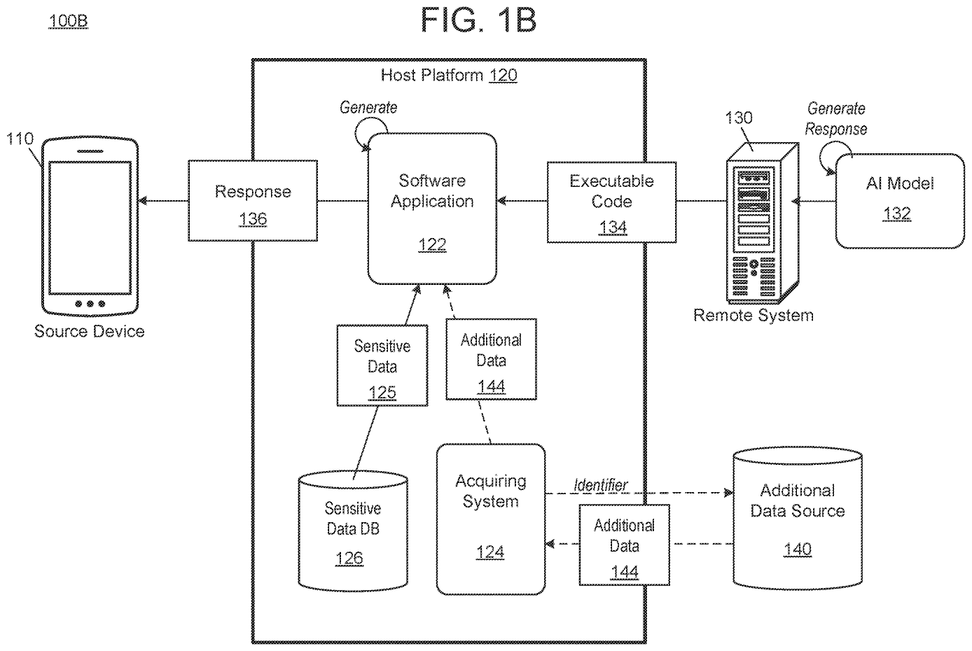

FIG. 1A illustrates a process 100A of augmenting input data for execution by a remote AI model according to examples and features of the instant solution. Referring to FIG. 1A, a host platform 120, such as a cloud platform, a web server, a database, a combination of systems, and the like, may host a software application 122 which relies on predictions/inferences made by an AI model 132 hosted by an external system 130. The software application 122 may have access to sensitive data (e.g., financial data, account numbers, personally identifiable information (PII), contact information, social security numbers, driver's licenses, credit card numbers, passwords, usernames, residence information, etc.) The sensitive data may be prevented, by laws, regulations, corporate policy, contractual agreements, and the like, from leaving possession of the host platform 120.

However, for various reasons, the host platform 120 may desire to use an AI model, such as the AI model 132, on a remote system. As one example, the host platform may not have its own AI model, such as an LLM. As another example, the host platform 120 may host its own AI model, but the AI model 132 hosted by the external system 130 may be more accurate at generating responses, faster, easier to scale with, and the like. Therefore, the host platform 120 may use the “non-sensitive” data from a user input to request a response from the AI model 132 hosted on the external system 130.

In the example of FIG. 1A, the host platform 120 may receive input data 112 submitted/uploaded from a source device 110. As an example, the input data 112 may be typed into a display device 111 using a touchpad, spoken and recorded by a microphone of the source device 110, or the like. The input data 112 may include a natural language query, or the like, along with personal information or the like. The source device 110 may include a mobile device, a laptop computer, a desktop computer, a tablet, or the like. The source device 110 may connect to the host platform 120 over a computer network, such as the Internet, a private network, a combination thereof, and the like. For example, the software application 122 may be a web application accessible at a predefined uniform resource locator (URL) with a browser such as a web browser, mobile browser, and the like.

The software application 122 may analyze the input data 112 and detect a portion of the input data 112 as sensitive data 125. For example, the sensitive data 125 may include personally-identifiable information (PII) such as a name, an address, an email address, a phone number, a social security number, an account number, a username, a password, a name of a family member, and the like. The sensitive data 125 may be redacted or otherwise removed from the input data 112 and temporarily stored within a sensitive data database 126 to generate augmented input data 112b. As another example, the software application 122 may also acquire or otherwise collect additional data about a question, about a source device, about an owner/user of the source device, and the like, from an additional data source 140 such as a publicly-available database.

For example, the software application 122 may use an acquiring system 124 to query the additional data source based on an identifier (e.g., name, device ID, account number, etc.) and obtain additional data 142 associated with the source device 110. The additional data 142 may be used to generate a response and/or augment a response. For example, the additional data 142 may be included in the augmented input data 112b that is transferred to the external system 130 over a network such as the Internet. The external system 130 may execute the AI model 132 on the augmented input data 112b to generate executable source code that can be executed by the software application 122 to generate a response to the input data 112.

FIG. 1B illustrates a process 100B of generating a response based on code from the remote AI model according to examples and features of the instant solution. Referring to FIG. 1B, the AI model 132 may generate executable source code 134 which can be executed by the software application 122 to generate a response 136 to a natural language query or the like within the input data 112.

For example, the augmented input data 112b that is fed to the AI model 132 may include instructions or task which specifies that the AI model 132 is to generate code in a predefined programming language (e.g., Python, etc.) which can be executed to generate an answer to the question. This ensures that the data used by the code during execution can be used from the host platform 120, where the sensitive data can reside, rather than the external system 130 which is prohibited. Thus, the example embodiments enable an AI model to generate a response without the exchange of sensitive data. However, the sensitive data can still be integrated back into the final response. For example, a local AI model may receive the response generated by the external AI model, and the sensitive data removed from the input data, and generate a more accurate response that can then be output to the source device.

In the example of FIG. 1B, the executable source code 134 is provided to the software application 122 from the external system 130. In addition, the sensitive data 125 is provided back to the software application 122 along with any additional data 144 that is desired from an external system such as the additional data source 140. In response, the software application 122 can execute the executable source code 134 on the input data 112 including the sensitive data 125 and any additional data 144 to generate a response 136. The response 136 may then be output to the source device 110 where it can be viewed on the display device 111 of the source device 110.

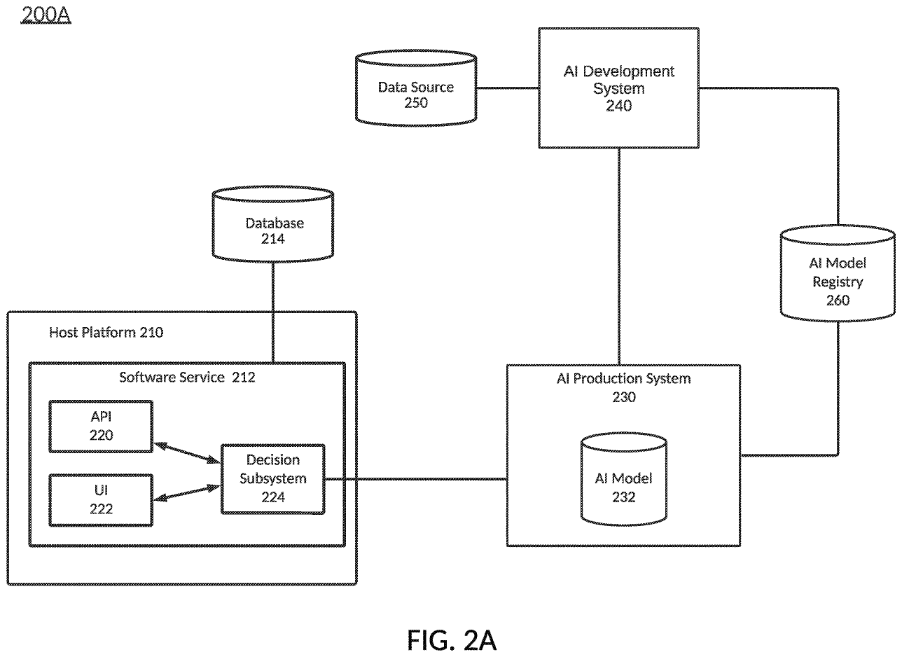

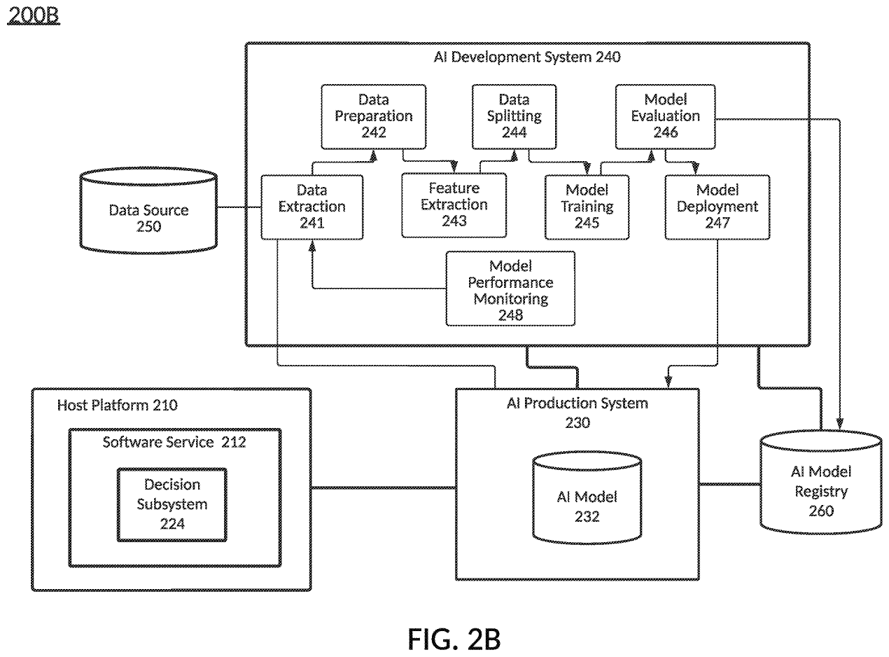

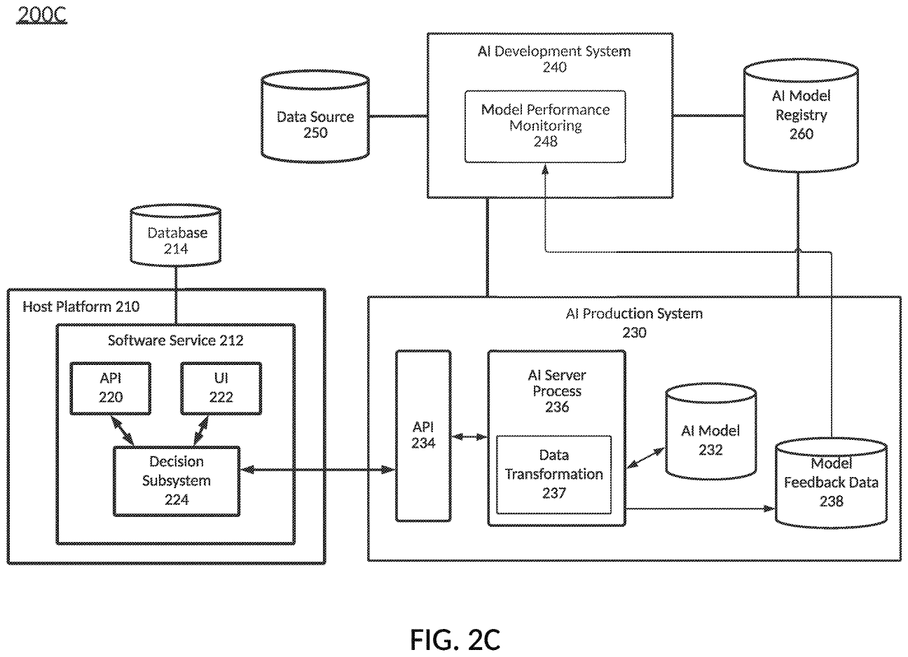

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 212 (see FIG. 2A), executing on host platform 210 may provide at least one API 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of APIs 220 send data to at least one decision subsystem 224 of the software service 212 to assist in decision-making. In some examples and features of the instant solution, the software service 212 stores data included in API requests or data generated during processing the API requests into at least one database 214.

Software service 212 may provide at least one user interface (UI) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to at least one decision subsystem 224 of the software service 212 to assist with decision-making. In some examples and features of the instant solution, the software service 212 stores data included in UI requests or data generated during processing the UI requests into at least one database 214.

Software service 212 may include at least one decision subsystem 224 that drive a decision-making process of the software service 212. In some examples and features of the instant solution, the decision subsystems 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 214 to aid in the decision-making process. A decision subsystem 224 may provide feedback to an API 220 or a UI 222.

An AI production system 230 may be used by a decision subsystem 224 in a software service 212 to assist in its decision-making process. The AI production system 230 includes at least one AI model 232 that is executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 21,2 UI 222 data from software service 212 or data from other software service 212 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

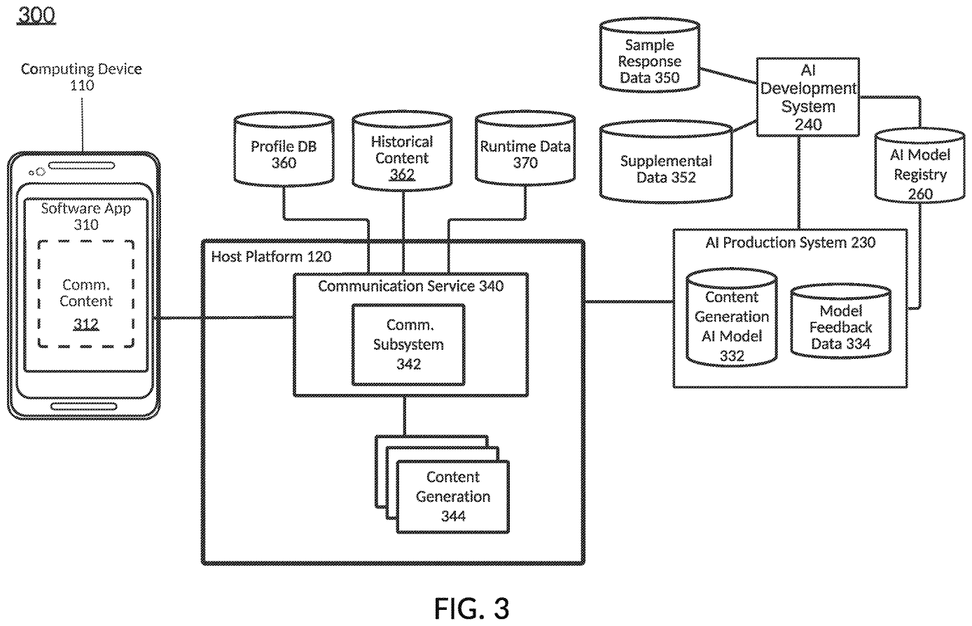

FIG. 3 illustrates an operating environment 300 for a communication service according to the examples and features of the instant solution. In some examples and features of the instant solution, a content generation AI model 332 is trained using at least one of historical call scripts and communication content, historical profile data, runtime data including feedback, and the like, to generate conversation content that can be injected into a communication session given a set of feature data transformed from a set of application data and computing device data. The content generation AI model 332 is an example of AI Model 232 (see, for example, FIGS. 2A-2C). The historical communication content, historical profile data, runtime data including feedback are examples of data source 250 (see, for example, FIGS. 2A-2C). The training of the content generation AI model 332 may be evaluated based on sample response data 350, supplemental data 352, and the like.

In some examples and features of the instant solution, the content generation AI model 332 is trained using at least one neural network training method such as, but not limited to, gradient descent, stochastic gradient descent, random search, uniform search, basin hopping, and Krylov. In some examples and features of the instant solution, the content generation AI model 332 is a single or multi-layer perceptron neural network, a feed-forward neural network, a radial basis functional neural network, a recurrent neural network, or a modular neural network.

In some examples and features of the instant solution, the content generation AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data for the content generation AI model 332 may include, but is not limited to, internal data sources, external data sources, private data sources, public data sources, historical call scripts, historical profile data, runtime data including feedback, historical communication content, profile data, and the like.

In some examples and features of the instant solution, historical call scripts may include, but is not limited to, call scripts previously recorded between the same devices, different devices, and the like. The historical call scripts may include the utterances that are spoken, identifiers of which user spoke which utterances, timestamps of each utterance, and the like. The utterance may include a textual description of the audio from a historical video call, phone call, web call, meeting, or the like. The historical profile data may include profile data of the users that participated in the historical calls including which calls the users participated in. The runtime data may include feedback that is automatically captured by the software and/or that is received from a GUI, etc.

The model feedback records in the model feedback data 334 may include, but is not limited to, inputs entered via a GUI which indicate whether the responses and other content generated by the content generation AI model 332 is accurate or not. As another example, the model feedback data 334 may include data that is automatically detected by the software application. For example, the software application may detect a change in conversation and infer that the response provide by the content generation AI model 332 solved the issue, etc.

Once the content generation AI model 332 is trained and validated, it is deployed to an AI production system 230 (see, for example, FIGS. 2A-2C, 3) for use by a communication service 340. The communication service 340 is an example of software service.

In some examples and features of the instant solution, software app 310, running on the source device 110, is an example of service client. The software app 310 may be a teleconferencing software application, a conferencing software application, a meeting software application, a call center software application, a mobile application, or the like. The software app 310 may enable users to speak with each other over a network such as a cellular telephone network, the Internet, and the like. The software app 310 may also display content on a GUI of the software app 310, such as communication content 312. The software app 310 may also display content generated by the content generation AI model 332.

In some examples and features of the instant solution, the communication service 340 receives data from the software app 310. The data may include, but is not limited to, call scripts, images, text, audio, and the like.

Additionally, the communication service 340 receives data about the source device 110. The device data may include, but is not limited to, the media access control (MAC) address and the source internet protocol (IP) address of the computing device.

For example, the communication service 340 may receive a communication from a software application such as an electronic message, an electronic form, application data, or the like. The communication service 340 may instantiate a communication subsystem 342 which extracts content from the communication and determines whether or not to the content is allowed to be sent to an exterior AI system, such as the content generation AI model 332. When the communication subsystem 342 determines to generate conversation content, the communication subsystem 342 executes a content generation 344 process which may call the content generation AI model 332 in the AI production system 230 for generative content that can be displayed, spoken, or the like, within the conversation. The call to the AI production system 230 may include content from the received communication. The content may include natural language content, transaction content, data from a profile database 360, a historical communication content database 362, a runtime database 370, and the like, in addition to the communication content.

In response to receiving the call, the content generation AI model 332 may generate a response to the input communication content that may include at least one of an utterance, a phrase, a script, a source code program, and the like, which can be output during the conversation. The response may be provided to the communication service 340 and output to a GUI of the software app 310, spoken by a talking bot via the software app 310, and the like.

In the example embodiments, the AI model that may be used to generate the response may be an open source AI model, such as a large language model (LLM). The system may use the LLM because it is quick and easy to scale should the system need access to more instances of the AI model. However, the use of the external LLM requires the data to leave the security of the system for a host system of the LLM. To prevent sensitive data from being communicated to the external host system, the example embodiments may identify and redact sensitive data from the natural language input (and other input data), and send only the non-sensitive data to the LLM. Furthermore, the system may use information about the user, the device, the product, etc. to identify additional data that can be used to augment the response to be generated by the LLM.

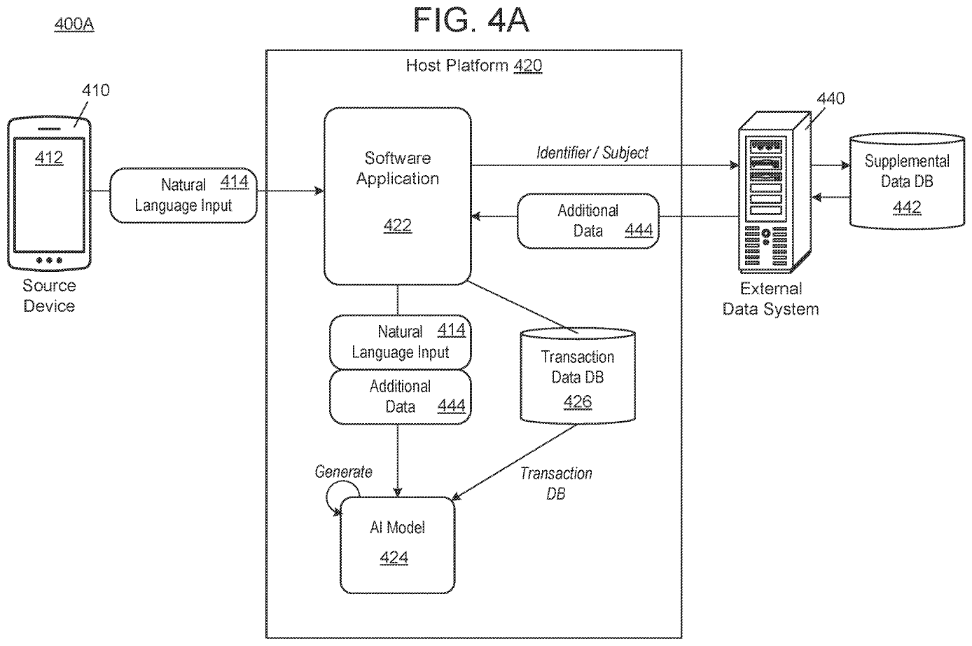

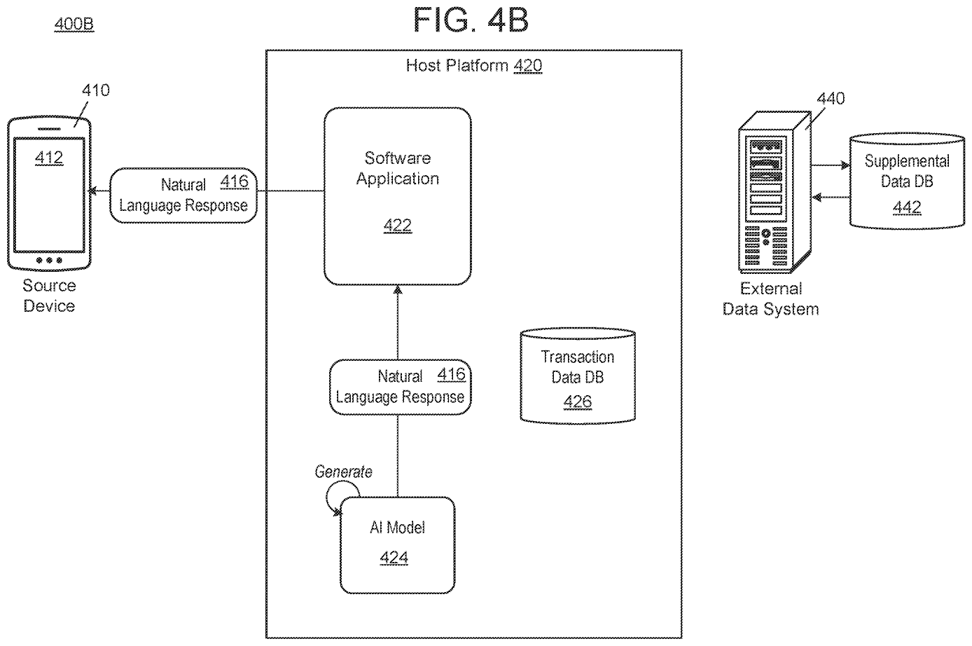

FIG. 4A illustrates a process 400A of enhancing input data that is being sent to an AI model according to the examples and features of the instant solution. For example, the AI model may be a large language model or other transformer that is capable of receive a natural language query and generating a natural language response to the natural language query. Referring to FIG. 4A, a host platform 420 may host a software application 422 that provides communication sessions (e.g., chat, voice, etc.) to a consumer using artificial intelligence. The software application 422 may receive natural language inputs (e.g., queries, questions, etc.) from a source device 410, and generate a natural language response to the natural language input.

In this example, the software application 422 receives a natural language input 414 from the source device 410. For example, the software application 422 may be accessed from a browser on the source device 410 via a browser extension. The user may input the natural language input 414 into a GUI on a display device 412 of the source device 410. As another example, the user may speak the natural language input 414 and it may be recorded by a microphone (not shown) on the source device 410. When the software application 422 receives the natural language input 414, the software application 422 can enhance the natural language input 414 with additional content.

In this example, the software application 422 may identify a topic, object, product, service, item, person, etc. that is associated with the natural language input 414 from the natural language input 414. For example, the topic may be identified by execution of an AI/ML model on the natural language input 414 (and other content from the conversation, etc.) In other embodiments, the topic may not be detected or used to retrieve the additional data. Instead, only an identifier of the source device 410, or a user thereof may be used.

The software application 422 may query an external data system 440 with the identifier and the topic (if applicable). In response, the external data system 440 may obtain additional data 444 associated with the identifier and/or the topic from a supplemental data database 442, and send the additional data 444 to the software application 422. In response, the software application 422 may combine the additional data 444 with the natural language input 414 and send the combination of input data to an AI model 424 that generates a response to the natural language input 414. In some embodiments, the software application 422 may also send transaction data, profile data, and the like, from a database 426 to the AI model 424, for use during the response generation.

In another example, the software application 422 employs a retrieval-augmented generation (RAG) algorithm that dynamically queries multiple external data sources to refine the natural language input 414 and enhance response generation. Upon receiving the natural language input 414 from the source device 410, the host platform 420 initiates a multi-source query, leveraging a vector search algorithm that computes similarity scores between the input and indexed knowledge repositories stored in the external data system 440. The retrieved additional data 444 is then ranked based on contextual relevance, employing a transformer-based ranking model that assigns priority to information with the highest semantic correlation to the input. The augmented input, which includes the natural language input 414 and the additional data 444, is then processed by the AI model 424, which generates a response based on the enriched context.

The software application 422 may implement a confidence scoring mechanism that evaluates the reliability of supplemental data from database 442, allowing for adaptive weighting of information sources. If multiple conflicting data points are retrieved, the host platform 420 may employ a reinforcement learning approach to iteratively refine the response generation process based on historical accuracy and transaction data from database 426. The final response is then synthesized, incorporating relevant external data while maintaining contextual coherence, and is outputted to the source device 410.

The system employs a context-aware ranking algorithm that prioritizes retrieved additional data 444 based on semantic relevance, contextual alignment, and reliability. Upon retrieving multiple data sources using a vector search algorithm, the host platform 420 assigns an initial similarity score to each retrieved entry using cosine similarity or Euclidean distance against the natural language input 414's embedding in a high-dimensional vector space. The AI model 424 then applies a transformer-based contextual filtering mechanism, such as BERT-based ranking, to analyze sentence structures, topic relevance, and named entity associations. Next, a confidence weighting function adjusts scores based on the credibility of external data system 440, where verified and frequently used data sources are weighted higher using Bayesian inference models.

When multiple retrieved entries contain conflicting information, the software application 422 applies a reinforcement learning approach, wherein prior user feedback and historical accuracy rates from database 426 are used to re-rank results dynamically. Finally, a multi-factor aggregation function combines semantic similarity, source reliability, and contextual weight to determine the final ranking order, ensuring that the most relevant and trustworthy data is integrated into the augmented input for response generation.

FIG. 4B illustrates a process 400B of generating a response based on the enhanced input data according to the examples and features of the instant solution. According to various embodiments, the AI model 424 may be an LLM or the like which is capable of generating a natural language response to the natural language input 414 and the additional data 444. The AI model 424 may be trained to generate natural language responses/conversation content when questions or otherwise queried by an external user or system.

Referring to FIG. 4B, the AI model 424 may generate a natural language response 416 based on execution of the AI model 424 on the natural language input 414 and the additional data 444. The additional data 444 may enable the natural language response 416 generated by the AI model 424 to be more accurate than if only the natural language input 414 were used. The additional data 444 can include additional relevant data about a user or account associated with the natural language input/conversation. The software application 422 may output the natural language response 416 to the source device 410. For example, the software application 422 may display the natural language response 416 on the display device 412 of the source device 410.

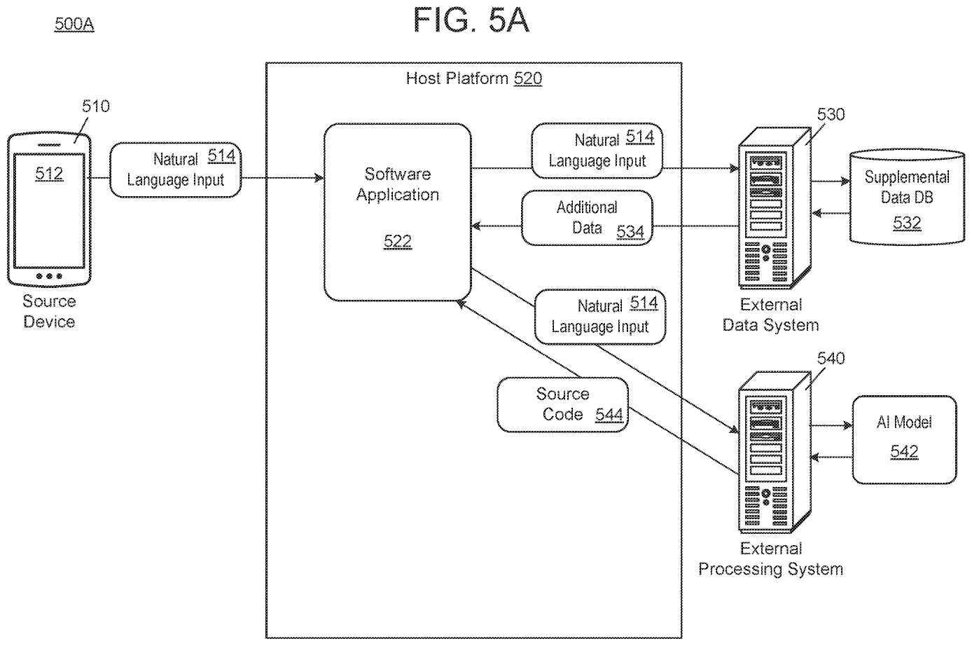

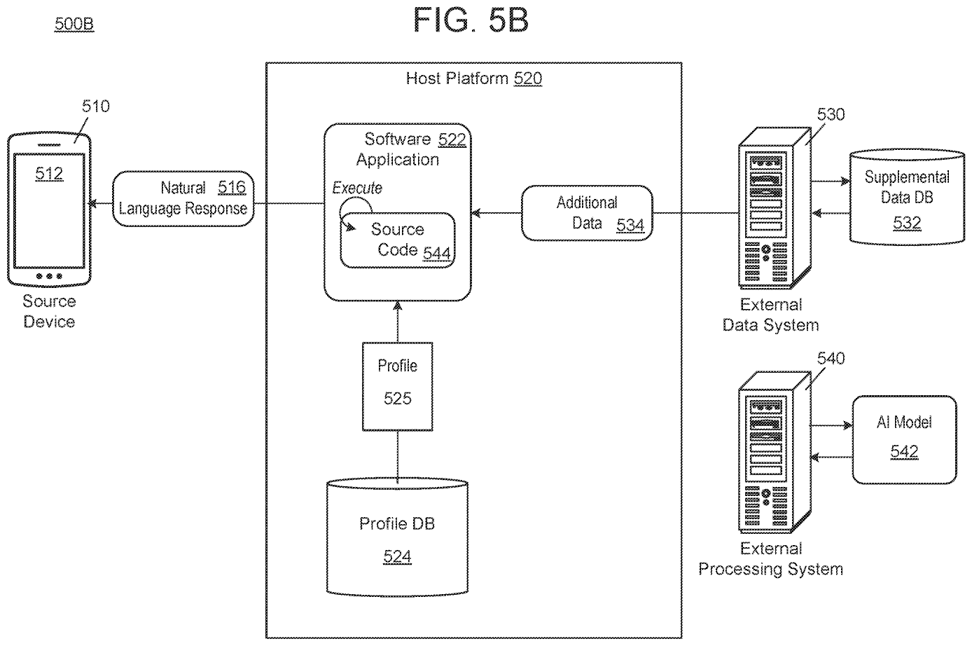

In the examples of FIGS. 4A and 4B, a local AI model is used to generate the natural language response. As another example, the natural language response may be generated or partially generated by an external AI model. However, transferring sensitive data to such an external AI model is typically not allowed (illegal). Therefore, external AI models are often ignored in favor of local AI models, when dealing with sensitive data. In the example embodiments, an external AI model can be used to generate a response to a natural language input, and the response can be based on the sensitive data. Rather than generate the answer, the external AI model can generate code that can be executed on data (e.g., sensitive data, non-sensitive data, etc.) to generate the answer to the natural language query. FIGS. 5A and 5B illustrate an example of this process.

FIG. 5A illustrates a process 500A of receiving source code and supplemental data according to the examples and features of the instant solution. Referring to FIG. 5A, a host platform 520 hosts a software application 522 that includes a communication function in which users can ask questions by submitting natural language inputs, and the software application 522 may respond with a natural language output/response. In this example, the host platform 520 uses an external AI model 542 hosted by an external processing system 540 to generate source code in a predefined programming language (e.g., Python, Java, C, etc.) that can be executed by the software application 522 on local data to generate the response.

In this example, the software application 522 receives a natural language input 514 from the source device 510, for example, based on an input on a display device 512 of the source device 510. The software application 522 may provide the natural language input 514 to the external processing system 540 which executes the external AI model 542 on the natural language input 514 to generate source code 544 for generating the response to the natural language input 514.

In addition, the software application 522 may also provide the natural language input 514 to an external data system 530 to obtain additional data associated with the source device 510. For example, the software application 522 may query the external data system 530 with a unique identifier such as a user, an account, a phone number, an email address, or the like, may be used to obtain additional relevant data. In response, the external data system 530 may identify additional data 534 that is related to the communication session based on the identifier, and send the additional data 534 to the software application 522. The software application 522 may use the additional data 534 and the source code 544 to generate the response.

FIG. 5B illustrates a process 500B of executing the source code 544 on the additional data 534 to generate a response to a natural language input according to the examples and features of the instant solution. Referring to FIG. 5B, the software application 522 may receive the source code 544 and execute the source code 544 on the additional data 534, any other additional data, profile 525 content from a profile database 524, and the like, and generate a natural language response 516 to the natural language input 514. The source code 544 may include the logic for generating the answer to a question raised by the user. The logic may identify values to be used and numerical calculations to be performed on the values.

In this example, the software application 522 may query the external data system 530 based on an identifier such as a user name, a phone number, an account identifier, an email address, or the like. In response, the external data system 530 may identify the additional data 534 within the supplemental data database 532 that is related to the identifier, and provide it to the software application 522. The software application 522 may execute the source code 544 on the additional data 534 within the computing environment of the host platform 520 to thereby generating an answer to the natural language query without sending the user's sensitive data outside of the host platform 520.

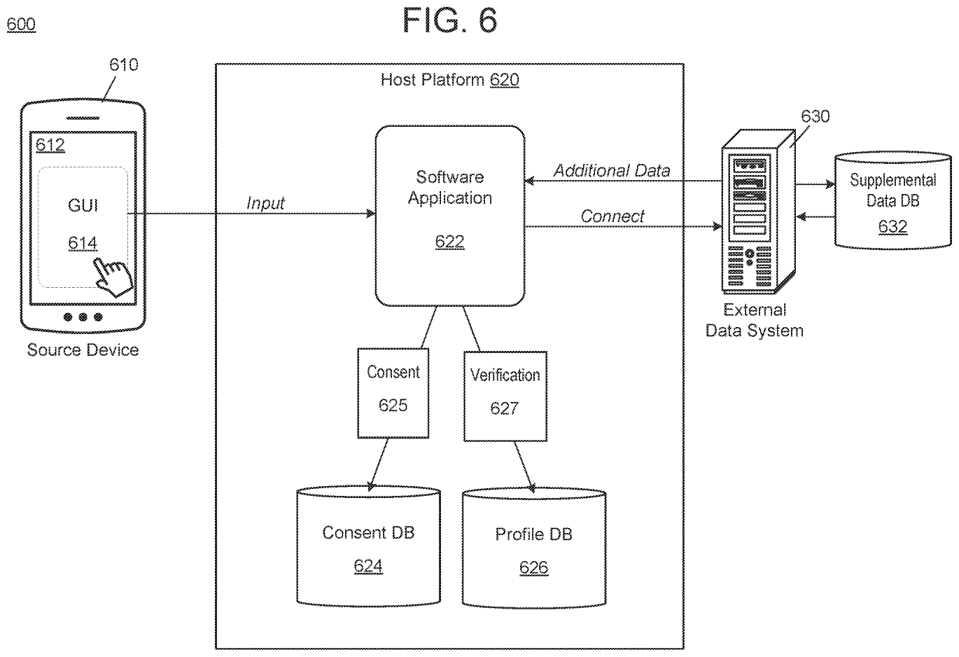

FIG. 6 illustrates a process 600 of a GUI being used to interact with the system described herein according to the examples and features of the instant solution. For example, the user of the source device may confirm or otherwise verify the accuracy of the additional data being used to generate the response prior to the additional data being executed by the AI model. The user may confirm the additional data through a GUI or the like. As another example, the user may also provide consent to access the user's data in the external data system through the GUI, or the like. Referring to FIG. 6, a software application 622 is hosted by a host platform 620. The software application 622 may correspond to the software application 422 or the software application 522.

In this example, the software application 622 requires the source device 610 to provide consent before the software application 622 can access data associated with the source device 610 at an external data system 630 which includes a supplemental data database 632. Here, the software application 622 may display controls, buttons, commands, etc. on a GUI 614 on a display device 612 of the source device 610. The user may input touch inputs, cursor inputs, keyboard inputs, or the like, to input commands to provide consent. The consent may be received by the software application 622 and recorded in a consent 625 file within a consent database 624.

The software application 622 may then access the data associated with the source device 610 from the external data system 630. For example, the software application 622 may send an identifier of a user of the source device 610, or a user's account, to the external data system 630. In response, the external data system 630 may identify data associated with the identifier within the supplemental data database 632 and send the additional data to the software application 622. However, prior to using the additional data, the software application 622 may display a request for verification of the accuracy of the additional data on the GUI 614 on the display device 612 of the source device 610. Accordingly, the software application 622 may wait to use the additional data until the user verifies the accuracy of the data by pressing commands on the GUI 614, or the like. The verification may be received by the software application 622 and recorded in a verification 627 file within a profile database 626.

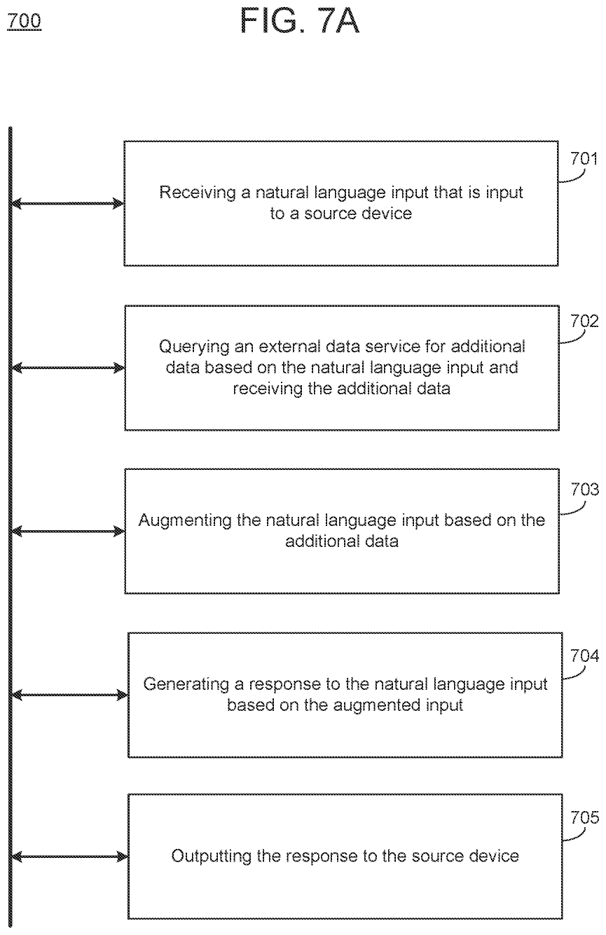

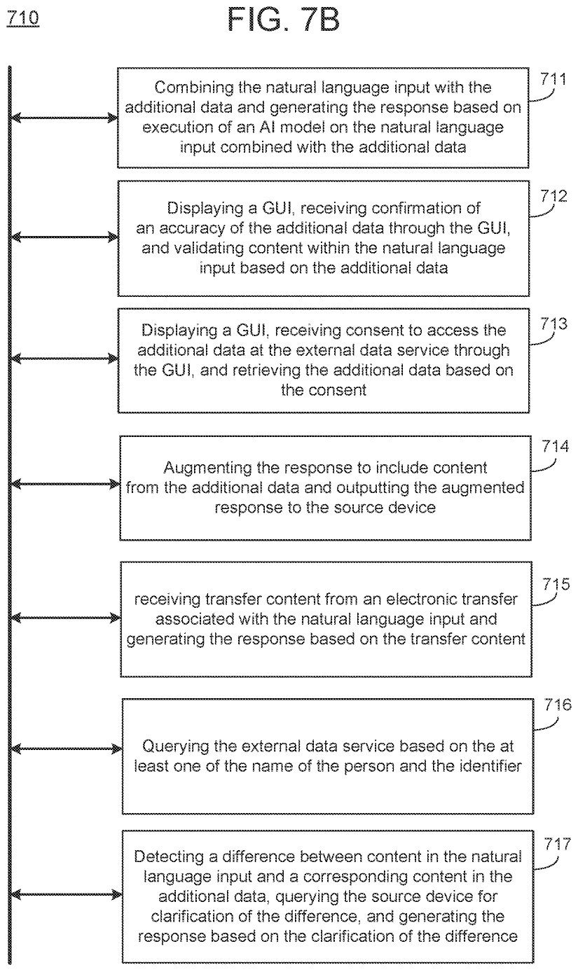

FIG. 7A illustrates a method 700 of augmenting a natural language input when generating a response according to the examples and features of the instant solution. As an example, the method 700 may be performed by a computing system, a software application, a server, a cloud platform, a combination of systems, and the like. Referring to FIG. 7A, in 701, the method may include receiving a natural language input that is input to a source device. In 702, the method may include querying an external data service for additional data based on the natural language input and receiving the additional data from the external data service. In 703, the method may include augmenting the natural language input based on the additional data to generate an augmented input. In 704, the method may include generating a response to the natural language input based on the augmented input. In 705, the method may include outputting the response to the source device.

FIG. 7B illustrates an additional method 710 of augmenting a natural language input when generating a response according to the examples and features of the instant solution. As an example, the method 710 may be performed by a computing system, a software application, a server, a cloud platform, a combination of systems, and the like. Referring to FIG. 7B, in 711, the method may include combining the natural language input with the additional data to generated the augmented input and generating the response based on execution of an artificial intelligence (AI) model on the natural language input combined with the additional data. In 712, the method may include displaying a GUI, receiving confirmation of an accuracy of the additional data from the source device through the GUI, and validating content within the natural language input based on the additional data.

In 713, the method may include displaying a GUI, receiving consent to access the additional data at the external data service through the GUI, and retrieving the additional data from the external data service based on the consent. In 714, the method may include augmenting the response to include content from the additional data and the outputting comprises outputting the augmented response to the source device. In 715, the method may include receiving transfer content from an electronic transfer associated with the natural language input, and generating the response based on the transfer content.

In 716, the natural language input includes at least one of a name of a person and an identifier associated with the source device and the querying includes querying the external data service based on the at least one of the name of the person and the identifier. In 717, the method may include detecting a difference between content in the natural language input and a corresponding content in the additional data, querying the source device for clarification of the difference, and generating the response based on the clarification of the difference.

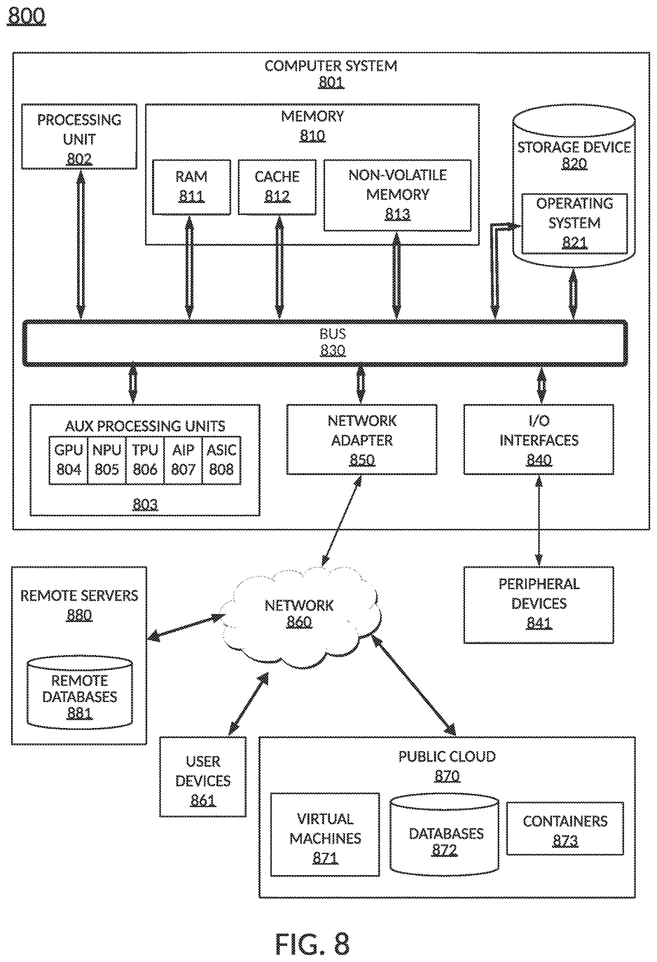

The examples and features of the instant solution may be implemented in at least one of the elements described or depicted herein, including for example, the elements described or depicted in FIG. 8. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates a computing environment according to the instant solution's example features, structures, or characteristics. FIG. 8 is not intended to suggest any limitation as to the scope of use or functionality of features, structures, or characteristics of the instant solution of the application described herein. Regardless, the computing environment 800 can be implemented to perform any of the functionalities described herein. In computing environment 800, there is a computer system 801, operational within numerous other general-purpose or special-purpose computing system environments or configurations.

Computer system 801 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 860 or querying a database. Depending upon the technology, the performance of a computer-implemented method may be distributed among multiple computers and among multiple locations. However, in this presentation of the computing environment 800, a detailed discussion is focused on a single computer, specifically computer system 801, to keep the presentation as simple as possible.

Computer system 801 may be located in a cloud, even though it is not shown in a cloud in FIG. 8. On the other hand, computer system 801 may not be in a cloud except to any extent as may be affirmatively indicated. Computer system 801 may be described in the general context of computer system-executable instructions, such as program modules, executed by a computer system 801. Generally, program modules may include routines, programs, objects, components, logic, data structures, and so on that perform tasks or implement certain abstract data types. As shown in FIG. 8, computer system 801 in computing environment 800 is shown in the form of a general-purpose computing device. The components of computer system 801 may include but are not limited to, at least one processor or processing unit 802, a system memory 810, and a bus 830 that couples various system components, including system memory 810 to processing unit 802.

Processing unit 802 includes at least one computer processor of any type now known or to be developed. The processing unit 802 may contain circuitry distributed over multiple integrated circuit chips. The processing unit 802 may also implement multiple processor threads and multiple processor cores. Cache 812 is a memory that may be in the processor chip package(s) or located “off-chip,” as depicted in FIG. 8. Cache 812 is typically used for data or code accessed by the threads or cores running on the processing unit 802. In some computing environments, processing unit 802 may be designed to work with qubits and perform quantum computing.

The Auxiliary Processing Units (APU) 803 may contain at least one Graphics Processing Unit (GPU) 804, Neural Processing Unit (NPU) 805, Tensor Processing Unit (TPU) 806, AI Processor (AIP) 807, or other Application Specific Integrated Circuit (ASIC) 808. The at least one APU 803 may contain circuitry distributed over multiple integrated circuit chips. Each APU 803 may implement multiple processor threads and multiple processor cores. Each APU 803 may include at least one of onboard memory, onboard memory cache, and onboard instruction cache. Each APU may be communicatively coupled to the system bus 830 and configure to communicate with other system components, including a processing unit 802, system cache 812, RAM 811, non-volatile RAM 813, operating system 821, Network adapter 850, and Input/Output interfaces 840. In some computing environments, at least one of the at least one APU 803 may be designed to work with qubits and perform quantum computing.

Memory 810 is any volatile memory now known or to be developed in the future. Examples include dynamic random-access memory (RAM) 811 or static type RAM 811. Typically, the volatile memory is characterized by random access, but this may not be the characterization unless affirmatively indicated. In computer system 801, memory 810 is in a single package. It is internal to computer system 801, but alternatively or additionally, the volatile memory may be distributed over multiple packages and/or located externally with respect to computer system 801. By way of example, memory 810 can be provided for reading from and writing to a non-removable, non-volatile magnetic media (shown as storage device 820, and typically called a “hard drive”). Memory 810 may include at least one program product having a set (e.g., at least one) of program modules configured to carry out the functions of various features, structures, or characteristics of the instant solution of the application. A typical computer system 801 may include cache 812, a specialized volatile memory generally faster than RAM 811 and generally located closer to the processing unit 802. Cache 812 stores frequently accessed data and instructions accessed by the processing unit 802 to speed up processing time. The computer system 801 may also include non-volatile memory 813 in the form of ROM, PROM, EEPROM, and flash memory. Non-volatile memory 813 often contains programming instructions for starting the computer, including the basic input/output system (BIOS) and information to start the operating system 821.

Computer system 801 may include a removable/non-removable, volatile/non-volatile computer storage device 820. For example, storage device 820 can be a non-removable, non-volatile magnetic media (not shown and typically called a “hard drive”). At least one data interface can connect it to the bus 830. In features, structures, or characteristics of the instant solution where computer system 801 has a large amount of storage (for example, where computer system 801 locally stores and manages a large database), then this storage may be provided by peripheral storage devices 820 designed for storing very large amounts of data, such as a storage area network (SAN) that is shared by multiple, geographically distributed computers.

The operating system 821 is software that manages computer system 801 hardware resources and provides common services for computer programs. Operating system 821 may take several forms, such as various known proprietary operating systems or open-source Portable Operating System Interface type operating systems that employ a kernel.

The bus 830 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 830 is the signal conduction path that allows the various components of computer system 801 to communicate.

Computer system 801 may communicate with at least one peripheral device, 841, via an input/output (I/O) interface, 840. Such devices may include a keyboard, a pointing device, a display, etc.; at least one device that enables a user to interact with computer system 801; and/or any devices (e.g., network card, modem, etc.) that enable computer system 801 to communicate with at least one other computing devices. Such communication can occur via I/O interface 840. As depicted, I/O interface 840 communicates with the other components of computer system 801 via bus 830.

Network adapter 850 enables the computer system 801 to connect and communicate with at least one network 860, such as a local area network (LAN), a wide area network (WAN), and/or a public network (e.g., the Internet). It bridges the computer's internal bus 830 and the external network, exchanging data efficiently and reliably. The network adapter 850 may include hardware, such as modems or Wi-Fi signal transceivers, and software for packetizing and/or de-packetizing data for communication network transmission. Network adapter 850 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 860 is any computer network that can receive and/or transmit data. Network 860 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 860 may be replaced and/or supplemented by LANs designed to communicate data between devices in a local area, such as a Wi-Fi network. The network 860 typically includes computer hardware such as copper transmission cables, optical transmission fibers, wireless transmission, routers, firewalls, switches, gateway computers, edge servers, and network infrastructure known now or to be developed in the future. Computer system 801 connects to network 860 via network adapter 850 and bus 830.

User devices 861 are any computer systems used and controlled by an end user in connection with computer system 801. For example, in a hypothetical case where computer system 801 is designed to provide a recommendation to an end user, this recommendation may typically be communicated from network adapter 850 of computer system 801 through network 860 to a user device 861, allowing user device 861 to display, or otherwise present, the recommendation to an end user. User devices can be a wide array, including personal computers, laptops, tablets, hand-held, mobile phones, etc.

A public cloud 870 is an on-demand availability of computer system resources, including data storage and computing power, without direct active management by the user. Public clouds 870 are often distributed, with data centers in multiple locations for availability and performance. Computing resources on public clouds 870 are shared across multiple tenants through virtual computing environments comprising virtual machines 871, databases 872, containers 873, and other resources. A container 873 is an isolated, lightweight software for running a software application on the host operating system 821. Containers 873 are built on top of the host operating system's kernel and contain software applications and some lightweight operating system APIs and services. In contrast, virtual machine 871 is a software layer with an operating system 821 and kernel. Virtual machines 871 are built on top of a hypervisor emulation layer designed to abstract a host computer's hardware from the operating software environment. Public clouds 870 generally offers databases 872, abstracting high-level database management activities. At least one element described or depicted in FIG. 8 can perform at least one of the actions, functionalities, or features described or depicted herein.

Remote servers 880 are any computers that serve at least some data and/or functionality over a network 860, for example, WAN, a virtual private network (VPN), a private cloud, or via the Internet to computer system 801. These networks 860 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 880 can also host remote databases 881, with the database located on one remote server 880 or distributed across multiple remote servers 880. Remote databases 881 are accessible from database client applications installed locally on the remote server 880, other remote servers 880, user devices 861, or computer system 801 across a network 860. An AI/ML model described or depicted here may reside fully or partially on any of the elements described or depicted in FIG. 8.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
at least one processor which is communicably coupled to the memory, wherein the at least one processor is configured to:
receive a natural language input that is input to a source device;
query an external data service for additional data based on the natural language input and receive the additional data from the external data service;
augment the natural language input based on the additional data to generate an augmented input;
generate a response to the natural language input based on the augmented input; and
output the response to the source device.

2. The apparatus of claim 1, wherein the at least one processor is configured to combine the natural language input with the additional data to generate the augmented input and generate the response based on execution of an artificial intelligence (AI) model on the natural language input combined with the additional data.

3. The apparatus of claim 1, wherein the at least one processor is further configured to display a graphical user interface (GUI), receive confirmation of an accuracy of the additional data from the source device through the GUI, and validate content within the natural language input based on the additional data.

4. The apparatus of claim 1, wherein the at least one processor is further configured to display a graphical user interface (GUI), receive consent to access the additional data at the external data service through the GUI, and retrieve the additional data from the external data service based on the consent.

5. The apparatus of claim 1, wherein the at least one processor is further configured to augment the response to include content from the additional data and output the augmented response to the source device.

6. The apparatus of claim 1, wherein the at least one processor is further configured to receive transfer content from an electronic transfer associated with the natural language input, and generate the response based on the transfer content, wherein an AI agent performs an action based on the response.

7. The apparatus of claim 1, wherein the natural language input includes at least one of a name of a person and an identifier associated with the source device and the at least one processor is configured to query the external data service based on the at least one of the name of the person and the identifier.

8. The apparatus of claim 1, wherein the at least one processor is further configured to detect a difference between content in the natural language input and corresponding content in the additional data, query the source device for clarification of the difference, and generate the response based on the clarification of the difference.

9. A method comprising:
receiving a natural language input that is input to a source device;
querying an external data service for additional data based on the natural language input and receiving the additional data from the external data service;
augmenting the natural language input based on the additional data to generate an augmented input;
generating a response to the natural language input based on the augmented input; and
outputting the response to the source device.

10. The method of claim 9, wherein the augmenting comprises combining the natural language input with the additional data to generated the augmented input and generating the response based on execution of an artificial intelligence (AI) model on the natural language input combined with the additional data.

11. The method of claim 9, wherein the method further comprises displaying a graphical user interface (GUI), receiving confirmation of an accuracy of the additional data from the source device through the GUI, and validating content within the natural language input based on the additional data.

12. The method of claim 9, wherein the method further comprises displaying a graphical user interface (GUI), receiving consent to access the additional data at the external data service through the GUI, and retrieving the additional data from the external data service based on the consent.

13. The method of claim 9, wherein the method further comprises augmenting the response to include content from the additional data and the outputting comprises outputting the augmented response to the source device.

14. The method of claim 9, wherein the method further comprises receiving transfer content from an electronic transfer associated with the natural language input, and the generating the response comprises generating the response based on the transfer content, wherein an AI agent performs an action based on the response.

15. The method of claim 9, wherein the natural language input includes at least one of a name of a person and an identifier associated with the source device and the querying comprises querying the external data service based on the at least one of the name of the person and the identifier.

16. The method of claim 9, wherein the method further comprises detecting a difference between content in the natural language input and a corresponding content in the additional data, querying the source device for clarification of the difference, and generating the response based on the clarification of the difference.

17. A computer-readable storage medium comprising instructions which when executed by a processor cause the processor to perform:
receiving a natural language input that is input to a source device;
querying an external data service for additional data based on the natural language input and receiving the additional data from the external data service;
augmenting the natural language input based on the additional data to generate an augmented input;
generating a response to the natural language input based on the augmented input; and
outputting the response to the source device.

18. The computer-readable storage medium of claim 17, wherein the augmenting comprises combining the natural language input with the additional data to generated the augmented input and generating the response based on execution of an artificial intelligence (AI) model on the natural language input combined with the additional data.

19. The computer-readable storage medium of claim 17, wherein the processor is further configured to perform displaying a graphical user interface (GUI), receiving confirmation of an accuracy of the additional data from the source device through the GUI, and validating content within the natural language input based on the additional data.

20. The computer-readable storage medium of claim 17, wherein the processor is further configured to perform displaying a graphical user interface (GUI), receiving consent to access the additional data at the external data service through the GUI, and retrieving the additional data from the external data service based on the consent.
